(19) United States
(12) Patent Application Publication
(10) Pub. No.: US 2003/0182197 A1
(43) Pub. Date: Sep. 25, 2003

(54) Apparatus and method for providing flexible purchase options

(75) Inventor: Jerry L. Beckman, Elk Point, SD (US)

Correspondence Address: Gateway, Inc., Law Department, MS Y04, 610 Gateway Drive, Box 2000, N. Sioux City, SD, 57049-2000, US

(73) Assignee: Gateway, Inc.

(21) Appl. No.: 10/106,015

(22) Filed: Mar. 25, 2002

(51) Int. Cl. G06F 17/60

(52) U.S. Cl. 705/26

(57) ABSTRACT

The present invention is directed to an apparatus and method for providing flexible purchase options, reminders and transaction performance. A method may include receiving a request for a good. Position of a portable communication device is monitored. A determination is made as to whether said request for the good may be satisfied by a provider location within a set proximity of said position. When the request may be satisfied, a user of said portable communication device and the provider location are notified.

### FIELD OF THE INVENTION

The present invention generally relates to the field of electronic transactions and e-commerce, and particularly to an apparatus and method for providing flexible purchase options, reminders and transaction performance.

### BACKGROUND OF THE INVENTION

E-commerce has become increasingly more popular as consumers select goods over the Internet. The range of goods available to a user has become increasingly more diverse, and consumer's confidence in this manner of dealing has likewise grown. However, even with this increasing popularity, there are many aspects to purchasing a good which still entail the use of actual physical locations to see and interact with the good, as well as the perceived security in being able to interact with a business on a personal level. Therefore, even with the proliferation of e-commerce, many businesses will still aim toward offering goods at a physical location that is accessible to prospective consumers.

For example, traditional business having store locations available to consumers may also try to benefit from e-commerce. A traditional seller, for instance, of a good at a physical store location may also have a web site that may tell of the store's benefits and inventory, and even enable a purchaser to perform a transaction online. From advertisements, to the ability to purchase actual goods both online and in person, “click-and-mortar” businesses utilizing both physical and online locations have become an abundant consumer option.

However, the advantages of a “click-and-mortar” business are typically underutilized. Consumers may not be aware of the options available from the business, such as physical store locations, the accessibility of the store to a consumer, inventory of the store, and the like. Thus, especially in large cities, store locations that are convenient to a consumer may not be exercised due to a lack of knowledge of the location. Using advertisements over traditional media as a way to increase such knowledge may not be successful in conveying to the user the synergy conveyed from the purchase options of both physical and online presences available to the consumer.

Further, consumers may decide to purchase, or be interested in, certain desired goods at times when the consumer is physically distant from a store's locations or from traditional information handling systems, such as information handling system wired to the Internet. In addition, it is often difficult for the consumer to keep track of all the different goods needed, such as home goods, office supplies, and the like. Therefore, a consumer may forget to make a purchase and may do so even in an instance where the purchase option was convenient, thus resulting in lost revenue opportunities for “click-and-mortar” businesses.

### SUMMARY OF THE INVENTION

Accordingly, the present invention is directed to an apparatus and method for providing flexible purchase options, reminders and transaction performance. In a first aspect of the present invention, a method includes receiving a request for a good. Position of a portable communication device is monitored. A determination is made as to whether said request for the good may be satisfied by a provider location within a set proximity of said position. When the request may be satisfied, a user of said portable communication device and the provider location are notified.

In a second aspect of the present invention, a method includes receiving a request for a good by a portable communication device, the portable communication device suitable for inputting data from a user and outputting data. The position of the portable communication device is monitored. A determination is made as to whether said request for the good may be satisfied by a provider location within a set proximity of said position. When the request may be satisfied, a user of the portable communication device is notified of presence of the requested good at the location.

In a third aspect of the present invention, an apparatus includes a portable communication device. The portable communication device is suitable for storing of electronic data and determining a position of the portable communication device with respect to a location. When the portable communication device receives a request for a good, a location of the portable communication device is monitored. When the portable communication device is positioned within a predetermined proximity to a location having the requested good, the portable communication device notifies a user of the portable communication device of presence of the requested good at the location.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an embodiment of the present invention wherein a portable communication device is suitable for notifying a consumer of a requested good;

FIG. 2 is an illustration of an embodiment of the present invention wherein a portable communication device includes an ability to determine position;

FIG. 3 is a flow diagram illustrating an exemplary method of the present invention wherein a position is monitored for proximity to a location having a requested good;

FIG. 4 is a flow diagram depicting an exemplary method of the present invention wherein a portable communication device checks good availability;

FIG. 5 is a flow diagram of an exemplary method of the present invention wherein a time parameter is included with a request for a good;

FIG. 6 is a flow diagram illustrating an embodiment of the present invention wherein notifications are utilized to provide additional transaction and service options; and

FIG. 7 is a flow diagram illustrating an embodiment of the present invention wherein a search for an urgent good is performed based on location from multiple providers if necessary.

### DETAILED DESCRIPTION OF THE INVENTION

Reference will now be made in detail to the presently preferred embodiments of the invention, examples of which are illustrated in the accompanying drawings.

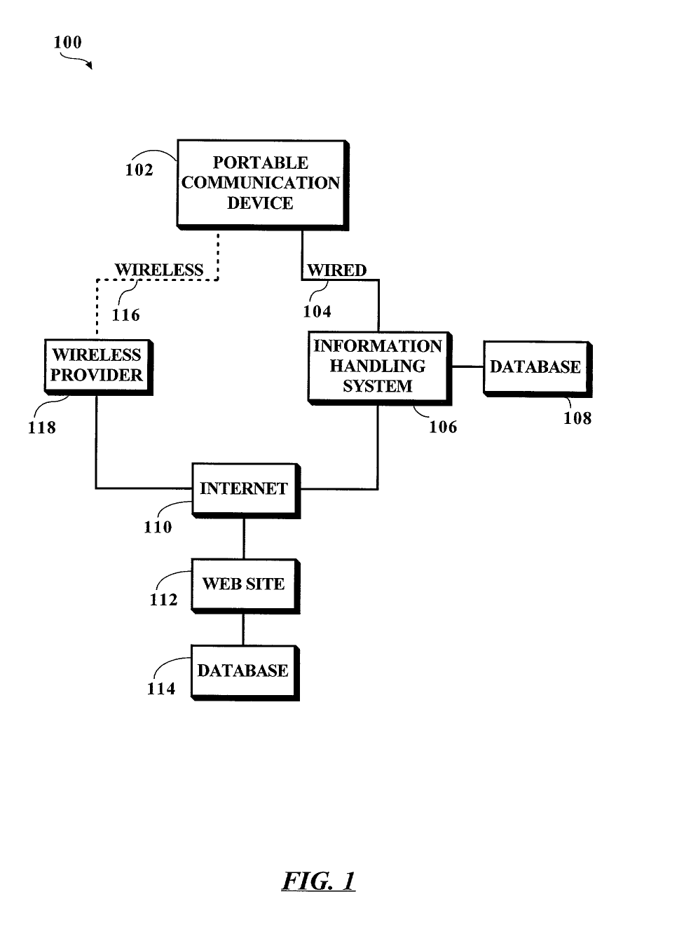

Referring generally now to FIGS. 1 through 7, exemplary embodiments of the present invention are shown. The present invention provides a solution to “click-andmortar” businesses that desire an answer for capturing purchase decisions at the time the decisions are made, which may also store the information, and may alert a customer at a convenient opportunity to purchase the goods.

Referring now to FIG. 1, an embodiment 100 of the present invention is shown wherein a portable communication device is suitable for notifying a consumer of a requested good. A portable communication device 102, such as a wireless phone including a cell phone, a personal digital assistant, portable information handling system, and the like, may be capable of accessing information from a wide range of sources. For instance, a portable communication device 102 configured as a wireless phone may access data through a wired connection 104, such as through a cradle to remote locations such as a home or office PC, or a local location such as in a store through a register cradle, and the like, to connect to an information handling system 106, which may be located locally, remotely, and the like. The information handling system 106 may include a database 108 of relevant information, as well as provide a connection to the Internet 110 and the web sites 112 contained therein. The web site 112 may also include a database 114 of information relevant to a user of the wireless phone 102. Additionally the portable communication device 102 may connect through a wireless connection 116 to a wireless provider 118 to enable mobile access to the Internet 110. The portable communication device 102 may also include the ability to determine its location in both mobile and stationary uses.

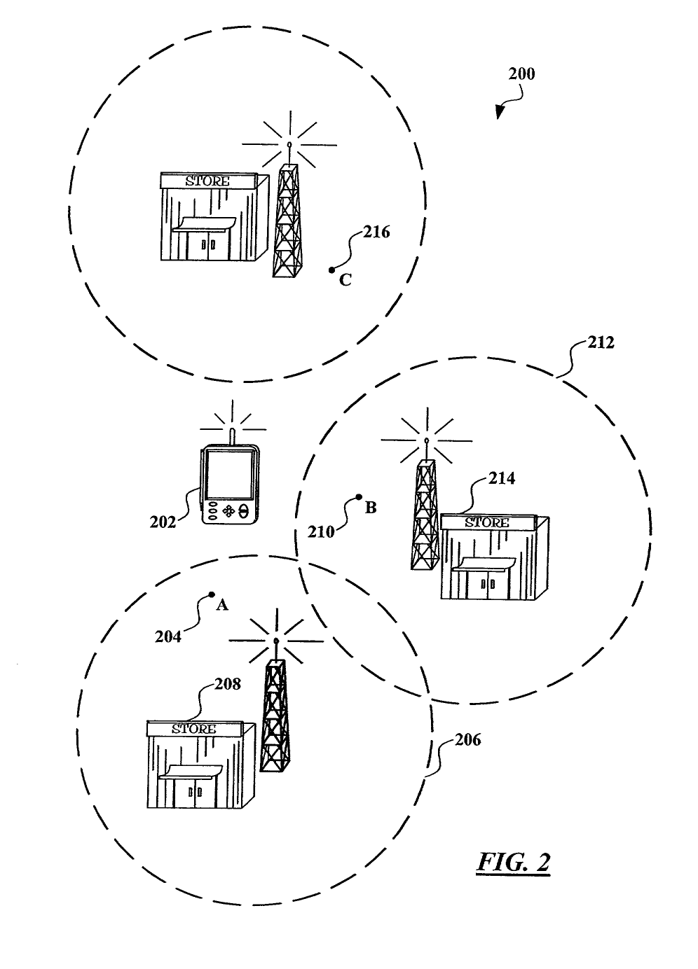

For instance, referring now to FIG. 2, an embodiment 200 of the present invention is shown wherein a portable communication device includes an ability to determine position. A portable communication device 202, in this configured as a personal digital assistance having communication capabilities, includes the ability to determine position of the device with respect to a location. This determination may be accomplished by the portable communication device utilizing a variety of mechanisms, such as a global positioning system (GPS) receiver, determine signal strength from a broadcast from a position, receive position data from a communication of data, and the like as contemplated by a person of ordinary skill in the art. By providing the ability to determine position and the ability to access data in a portable device, the present invention enables flexible purchase options to a consumer in a convenient manner making it possible to capture purchase decisions at the time the decision is made and retain this decision until it is convenient to actually obtain the goods.

A portable communication device, for example, may capture a purchase decision by a user at the time it is made through the portable nature and data entry properties of the device. A user may wish to purchase a certain good, and may make such decision while at the office, traveling between locations, and the like. The user may then enter this data into the portable communication device, which may then store the information. The portable communication device may then monitor position, and when located with a location having the good, such as a second location, the portable communication device may then remind the user. Thus, the user is reminded of the previous desire to purchase the good at a convention time for the user to purchase the good, such as when positioned in proximity to a location offering the good.

For instance, a user may travel from a first point “A” 204, at which, the portable communication device determines that the device is within proximity to a location 208 having a good which was previously indicated on the portable communication device. The user may then travel to point “B” 206 wherein an additional determination is made as to the position of the portable communication device, in this instance, in proximity 212 to a second location 214 having an additional good stored on the portable communication device. Such determinations may continue as the user continues to travel, such as to point C 216.

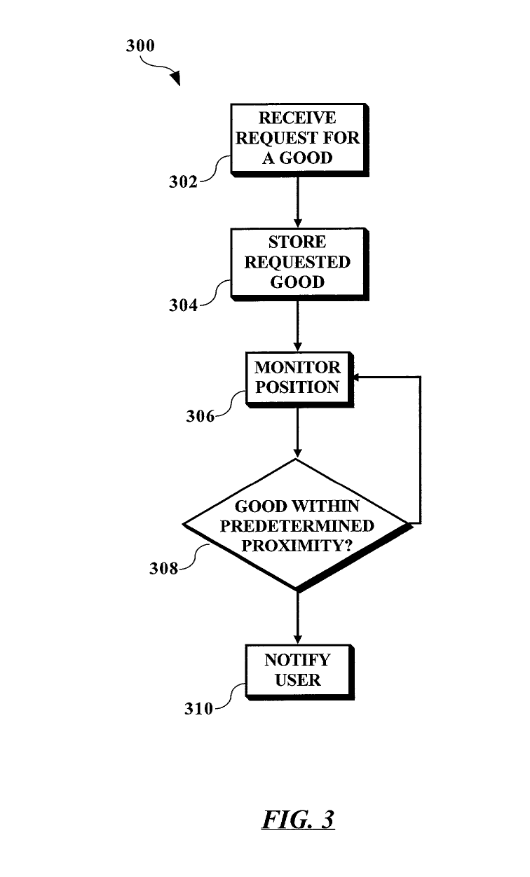

Referring now to FIG. 3, an exemplary method 300 of the present invention is shown wherein a position is monitored for proximity to a location having a requested good. A request for a good is received 302, such as by receiving data entered by a user on a portable communication device through a touch screen, keypad, voice recognition, and the like, data transferred from an information handling system, and like methods without departing from the spirit and scope of the present invention. The requested good is stored 304, such as by storing data indicating the good requested. Position of the portable communication device is monitored 306, such as utilizing the mechanisms described in relation to FIG. 2.

If the item is within a predetermined proximity to the portable communication device 308, the device notifies the user 310. For instance, a portable communication device may include a GPS receiver for determining position of the portable communication and may also access a database of locations. The database may indicate the type of goods available at the location, and may contain a listing of goods actually present at the location, and the like. The database may be included on the portable communication device itself, accessible over a wireless network, and like configurations as contemplated by a person of ordinary skill in the art.

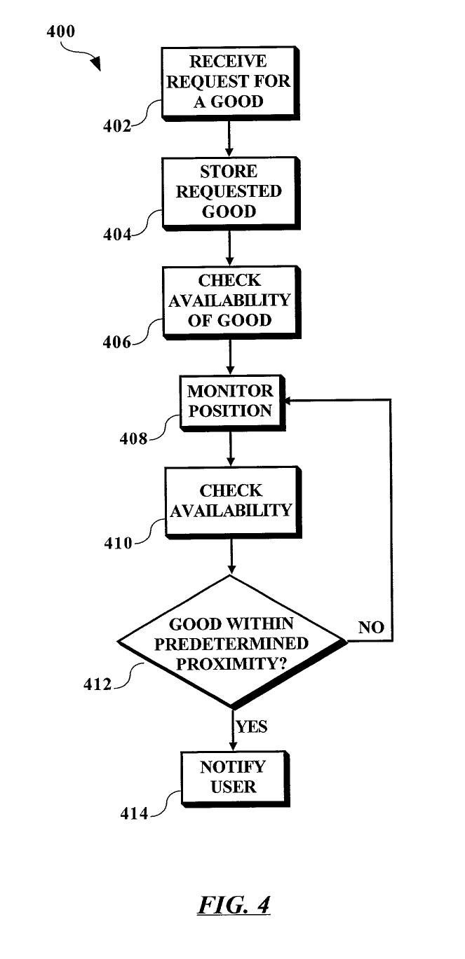

Additionally, a portable communication device may utilize both location type and confirm presence of goods before notifying a user. For example, referring now to FIG. 4, an exemplary method 400 of the present invention is shown wherein a portable communication device checks good availability. A consumer may determine that a particular good is needed and enter the good into a portable communication device, which receives the request 402 from the entered data and stores the data 404. The portable communication device may at this time check availability of the good 406, such as along routes frequented by the consumer that were stored previously by the portable communication device, within a certain radius of the current location, and the like. In additional embodiments, if the good is not with a desired route, radius, and the like, the portable communication device may notify the user, and give the user the option to purchase the good over a wireless connection to the Internet.

A portable communication device may also check good availability at a later time for an “up-to-date” determination. For instance, days later, when the consumer is traveling about a city, the portable communication device, through use of an ability to monitor position 408, determines that the device is located within proximity to a type of store having the good as indicated by an internal database. The portable communication device may then access an inventory database, such as by contacting the nearby location, accessing an online database, and the like, to check availability 410. If the good is available with the predetermined proximity 412, the portable communication device may then notify the user 414. A portable communication device may notify a user utilizing a variety of different methods, such as distinctive sound outputs, displays of data, and the like, depending on whether the goods is available, location of the good, and the like. In this way, the portable communication device verifies a good is actually present at a location before notifying the user, thereby enabling a more efficient use of a consumer's time and further promoting convenience to the consumer. However, usefulness and/or desire of a particular good may wane after a period of time, thereby making the purchase of such item less relevant to a user.

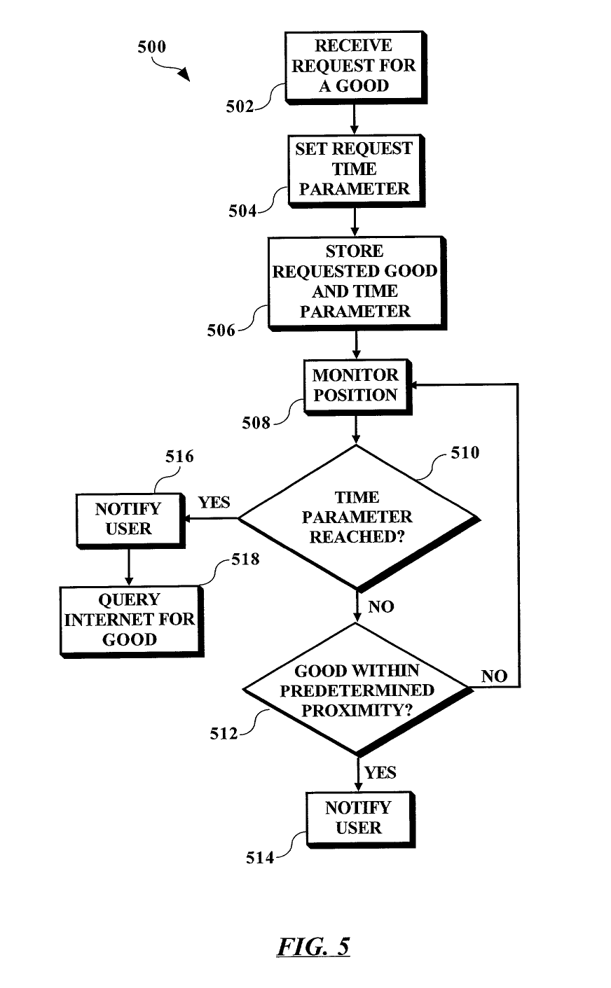

Referring now to FIG. 5, an exemplary method 500 of the present invention is shown wherein a time parameter is included with a request for a good. A request for a good is received 502. A time parameter is then set for the request 504. Setting a time program may be done automatically, such as by utilizing a default time for utilizing the request, entered by a user in conjunction with the request, and the like. The requested good and the time parameter are stored 506, such as to an internal database of a portable communication device, stored on an information handling system 106 (FIG. 1) accessible to the portable communication device, stored on a web site 112 (FIG. 1), and the like as contemplated by a person of ordinary skill in the art.

Position of the portable communication device is monitored 508 as described previously. Additionally, a determination is made as to whether the time parameter has been reached 510. If the time parameter has not been reached 510, the portable communication device may continue to determine with a location and a good are within predetermined proximity 512, and if so, notify the user 514. However, if the time parameter has been reached 510, the user may be notified 516, such as to enable the user to extend the time parameter, delete the request, and the like. Additionally, the portable communication device may give the option to purchase the good of the Internet, such as by querying the Internet for the good 518. Thus, the present invention may provide timely good purchases, and may further provide additional options for purchasing the goods should a convenient opportunity not present itself.

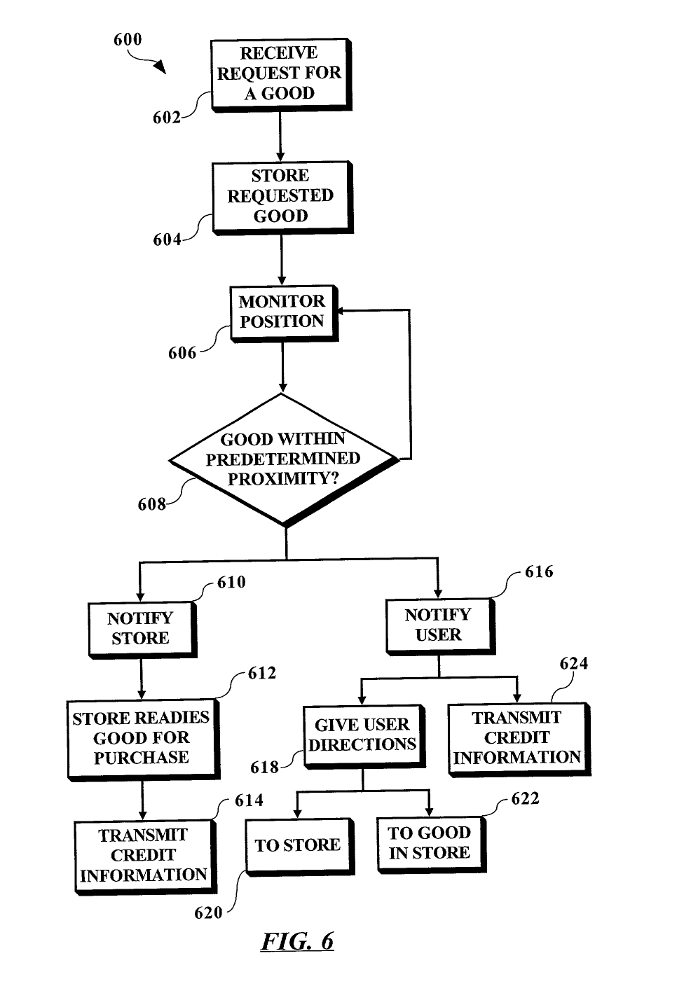

Referring now to FIG. 6, an exemplary method 600 of the present invention is shown wherein notifications are utilized to provide additional transaction and service options. By enabling a consumer and a seller advanced notification of availability of goods and desire of a consumer to obtain the goods, a variety of additional services and options may be provided to increase the efficiency and desirability of the transaction to a seller and a consumer.

For instance, a portable communication device may receive a request for a good 602 a store the requested good 604. The position of the portable communication device is monitored 606. If a good is determined to be at a location within a predetermined proximity, the location may be notified 608. For example, if the good is located at a store, the store may be notified 610, so that the store readies the good for purchase 612, such as retrieving the good from a shelf, and the like. Additionally, credit information may be transferred 614 so that the good is purchased and just needs to be picked-up from the store. It should be apparent that notifying a provider of goods may take a variety of forms without departing from the spirit and scope of the present invention.

Additionally, notifying a user 616 may include a variety of actions. For instance, directions may be given to a user 618, such as to the store having the desired good 620, to the location of the good within the store 622, and the like. Credit information may also be transferred 624 by the portable communication device upon retrieval of the good to enable efficient and user-friendly transaction processing. In this way, a portable communication device of the present invention may provide a variety of functions to enable flexible transaction processing, retrieval of goods, reminding a user of the previous desire for the good, location of the goods when convention, and the like.

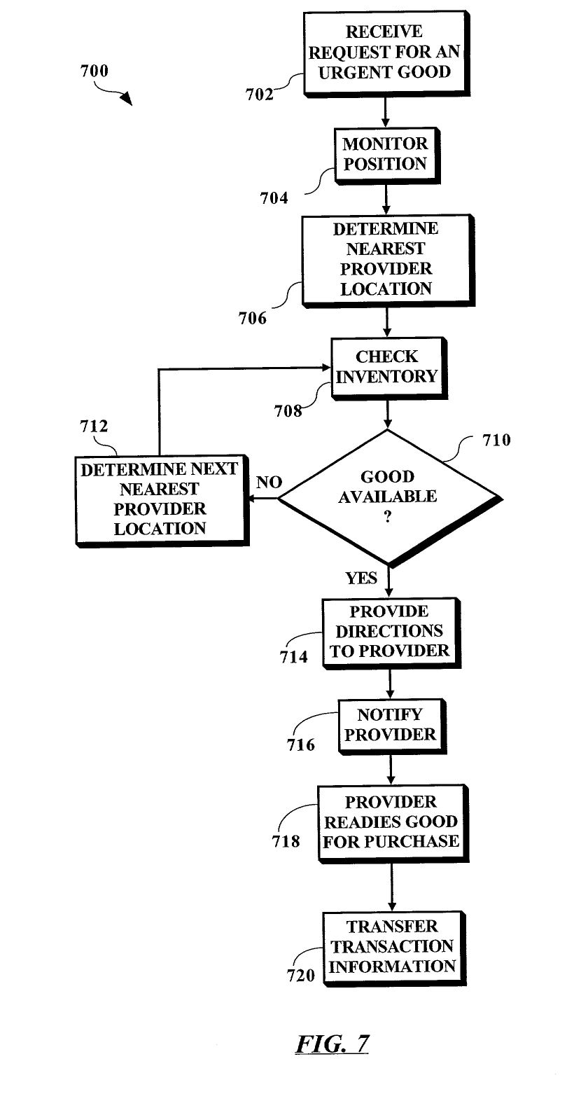

Referring now to FIG. 7, an exemplary method 700 of the present invention is shown wherein a search for an urgent good is performed based on location from multiple providers if necessary. A user may encounter instances is which a good is urgently needed, such as the need for a new tire due to a flat tire on an automobile, and want to determine a closest location having the good, but also want to still get a reasonable deal on the good. For instance, a request for an urgent good may be received 702, such as from a user indicating on a device employing the present invention that the good is needed presently. The position of the user is monitored 704 and a nearest provider location is determined 706. The inventory of the provider is queried 708 to determine if the good is available 710. If the good is not available 710, a next nearest provider location is determined 712, and the query continued. Additionally, in an additional aspect of the present invention, parameters may be included in the query, such as preferred providers, warranty information relating to the desired good, desired good configurations and options, and the like as contemplated by a person of ordinary skill in the art.

Once a provider location having the good available is determined 710, the directions to the provider are given 714. Additionally, the provider is notified 716 so that the provider may ready the good for purchase 718, such as retrieving the item from a warehouse, back room, shelf and the like. Transaction information may also be transferred from an apparatus of the present invention to the provider 720 to complete the transaction, such as by giving credit information and the like.

By providing a portable communication device of the present invention, sellers and consumers may be linked in a manner convenient and efficient to the user, thereby increasing seller exposure in a manner which is unobtrusive to the consumer. Therefore, major providers of goods, such as large retail outlets, may promote portable communication devices of the present invention to increase exposure of the provider, such as by free giveaways, certain amount of free communication using the device, and the like.

Additionally, the portable communication devices may be part of promotions between retailers and service providers, in which a retailer may receive a portion of the profits for selling the device, receive automatic referral fees based on users availing themselves of the features, such as automatically transferring a certain value to a provider of the device when a consumer enters a store because of the device functionality, a consumer may receive credits for such usage, and like mechanisms as contemplated by a person of ordinary skill in the art. For instance, a portable communication device of the present invention may include downloaded with product offerings, graphical pictorials of products and pricing, and the like. The portable communication device may also receive updated offerings when attached through a cradle to an information handling system, and the like.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the apparatus and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method, comprising:
receiving a request for a good;
monitoring a position of a portable communication device; and
determining whether said request for the good may be satisfied by a provider location within a set proximity of said position, when the request may be satisfied, notifying a user of said portable communication device the request may be satisfied and notifying the provider location.

2. The method as described in claim 1, wherein the portable communication device includes a wireless phone, personal digital assistant, and portable information handling system.

3. The method as described in claim 1, further comprising checking availability of the good, wherein checking includes at least one of accessing at least one network site corresponding to a provider of goods, the network site suitable for indicating availability of a good at a location of a provider of goods; and the good is not available from a location, availability of the good at a next nearest provider location is checked.

4. The method as described in claim 1, wherein monitoring includes a time parameter.

5. The method as described in claim 1, wherein directions are given to the user to the provider location of the good of the requested item.

6. The method as described in claim 1, wherein the provider location includes a store, directions are given to the user of the placement of the good within the location.

7. The method as described in claim 1, wherein position is monitored by at least one of a global positioning system and signal from the location of the provider of the goods.

8. A method, comprising:
receiving a request for a good by a portable communication device, the portable communication device suitable for inputting data from a user and outputting data;
monitoring a position of a portable communication device; and
determining whether said request for the good may be satisfied by a provider location within a set proximity of said position, when the request may be satisfied, notifying a user of the portable communication device of presence of the requested good at the location.

9. The method as described in claim 8, wherein the portable communication device includes a wireless phone, personal digital assistant, and portable information handling system.

10. The method as described in claim 8, further comprising checking availability of the good.

11. The method as described in claim 10, wherein checking includes accessing at least one network site corresponding to a provider of goods, the network site suitable for indicating availability of a good at a location of a provider of goods.

12. The method as described in claim 10, wherein the good is not available from a location, availability of the good at a next nearest provider location is checked.

13. The method as described in claim 8, wherein monitoring includes a time parameter.

14. The method as described in claim 8, further comprising notifying the provider of goods at the monitored location of the request.

15. The method as described in claim 8, wherein directions are given to the user to the provider of the good of the requested item.

16. The method as described in claim 8, wherein the provider location includes a store, directions are given to the user of the placement of the good within the location.

17. The method as described in claim 12, wherein position is monitored by at least one of a global positioning system and signal from the location of the provider of the goods.

18. An apparatus, comprising;
a portable communication device, the portable communication device suitable for storing of electronic data and determining a position of the portable communication device with respect to a location, wherein the portable communication device receives a request for a good and a position of the portable communication device is monitored as within a predetermined proximity to a location having the requested good, the portable communication device notifies a user of the portable communication device of presence of the requested good at the location.

19. The apparatus as described in claim 18, wherein the portable communication device is configured as at least one of a wireless phone, personal digital assistant, and portable information handling system.

20. The apparatus as described in claim 18, further comprising checking availability of the good.

21. The apparatus as described in claim 20, wherein checking includes accessing at least one network site corresponding to a provider of goods, the network site suitable for indicating availability of a good at a location of a provider of goods.

22. The apparatus as described in claim 20, wherein the good is not available from a location, availability of the good at a next nearest provider location is checked.

23. The apparatus as described in claim 18, wherein monitoring includes a time parameter.

24. The apparatus as described in claim 18, further comprising notifying the provider of goods at the monitored location of the request.

25. The apparatus as described in claim 18, wherein directions are given to the user of at least one of to the provider location of the good of the requested item; and wherein the location includes a store, directions are given to the user of the portable communication device of the placement of the good within the location.

26. The apparatus as described in claim 18, wherein position is monitored by at least one of a global positioning system and signal from the location of the provider location of the goods.
